(19) United States
(12) Patent Application Publication
(10) Pub. No.: US 2021/0336972 A1
(43) Pub. Date: Oct. 28, 2021

(54) METHOD FOR DETECTING LOST ACCOUNT BASED ON MULTIPLE DIMENSIONS

(71) Applicants: Bluedon Information Security Technologies Corp., Guangzhou (CN); Bluedon Information Security Technologies Co., Ltd., Guangzhou (CN)

(72) Inventors: Zonggui Ke, Guangzhou (CN); Baoming Zhang, Guangzhou (CN); Xiaoning Qin, Guangzhou (CN)

(21) Appl. No.: 16/857,159

(22) Filed: Apr. 23, 2020

(51) Int. Cl. H04L 29/06

(52) U.S. Cl. CPC H04L 63/1416; H04L 63/1425

(57) ABSTRACT

The present invention discloses a method for detecting a lost account based on multiple dimensions. The method includes the steps of obtaining security event information of an account via a security device such as an Intrusion Prevention System (IPS)/an Intrusion Detection System (IDS)/a firewall/an anti-virus wall/or the like; obtaining uplink and downlink traffic information of the account via analysis on a traffic log; identifying a covert communication signal of the account via the analysis on the traffic log; identifying abnormal login information of the account according to the traffic log; identifying data leakage information of the account according to the traffic log; obtaining functional use information of the account in a service system according to the traffic log; obtaining service process security information according to the traffic log; and determining a risk score and a loss probability of the account to the abnormal information of the account.

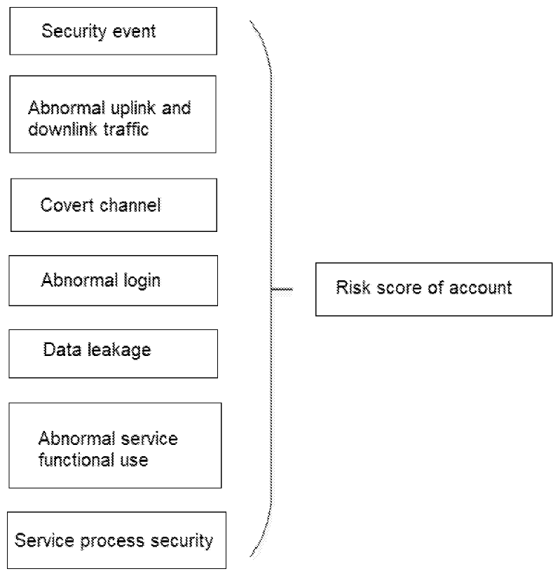

### TECHNICAL FIELD

The present invention relates to the technical field of Internet security, and in particular to a method for detecting a lost account based on multiple dimensions.

### BACKGROUND

It is typical to have an account in the digital era. In the contemporary society, each person owns multiple accounts on multiple software platforms. Some lawbreaker steals the account of other people to extract valuable information, which causes an economic loss to the society and the people. Therefore, when a state and a behavior of the account are abnormal, the abnormality of the account, that is, a loss of the account mentioned in the present invention, can be detected timely.

### SUMMARY

The present invention discloses a method for detecting a lost account based on multiple dimensions, including: obtaining security event information of an account via a security device such as an Intrusion Prevention System (IPS)/an Intrusion Detection System (IDS)/a firewall/an anti-virus wall/or the like; obtaining uplink and downlink traffic information of the account via analysis on a traffic log; identifying a covert communication signal of the account via the analysis on the traffic log; identifying abnormal login information of the account according to the traffic log; identifying data leakage information of the account according to the traffic log; obtaining functional use information of the account in a service system according to the traffic log; obtaining service process security information according to the traffic log; and determining a risk score and a loss probability of the account by using machine learning according to the abnormal information of the account.

Implementation Process:

1. A security device such as an IPS/an IDS/a firewall/an anti-virus wall or the like blocks, by means of restricted access on an ip and a port, tcp restricted connection, mode matching and other technologies, illegal access and forms a security event to generate a security event alarm of an account.

2. After a lawbreaker steals a personal account, relevant information of the account is leaked, and the account has an uplink traffic higher than a downlink traffic; and with analysis on the uplink and downlink traffic of the account, abnormal uplink and downlink traffic information of the account can be determined.

3. When the lawbreaker steals the personal account, the stolen personal account and password are leaked via a Domain Name System (DNS) covert communication; and at this time, with analysis on a traffic log, a covert communication signal of the account can be identified.

4. According to the traffic log, abnormal login information of the account is identified from five dimensions including an Internet Protocol (IP), time, a place, a device and whether a brute force is provided, thus providing a basis for a loss of the account.

5. Data leakage information of the account is identified according to the traffic log to provide the basis for the loss of the account.

6. Functional use information of the account in a service system is obtained according to the traffic log.

7. Service process security information is obtained according to the traffic log.

8. A risk score and a loss probability of the account are determined.

### BRIEF DESCRIPTION OF THE DRAWINGS

In order to describe the technical solutions in the embodiments of the present invention or in the conventional art more clearly, a simple introduction on the accompanying drawings which are needed in the description of the embodiments or conventional art is given below. Apparently, the accompanying drawings in the description below are merely some of the embodiments of the present invention, based on which other drawings may be obtained by those of ordinary skill in the art without any creative effort.

The sole FIGURE is a flowchart of the present invention.

### DETAILED DESCRIPTION OF THE EMBODIMENTS

Referring to the sole FIGURE, the solutions have the following implementation process:

1. A security device such as an IPS/an IDS/a firewall/an anti-virus wall or the like blocks, by means of restricted access on an ip and a port, tcp restricted connection, mode matching and other technologies, illegal access and forms a security event to generate a security event alarm of an account.

2. After a lawbreaker steals a personal account, relevant information of the account is leaked, and the account has an uplink traffic higher than a downlink traffic; and with analysis on the uplink and downlink traffic of the account, abnormal uplink and downlink traffic information of the account can be determined. The steps are as follows:

Step 1: a historical uplink and downlink traffic baseline of the account is constructed by using machine learning.

Step 2: real-time uplink and downlink traffic of the account is compared with the historical traffic baseline of the account.

Step 3: when the real-time uplink and downlink traffic of the account exceeds the historical traffic baseline, an abnormal uplink and downlink traffic alarm of the account is generated.

3. When the lawbreaker steals the personal account, the stolen personal account and password are leaked via a Domain Name System (DNS) covert communication; and at this time, with analysis on a traffic log, a covert communication signal of the account can be identified.

Step 1: the DNS covert communication stores the leaked data to a Query.Name field and an Answer field, possibly resulting in that a DNS data packet has an increased length. Therefore, by setting a threshold β of a DNS message, a data stream in which the DNS message has a total length greater than the threshold β is filtered. With a base64 encoding manner, the covert data makes a distribution more random and a character entropy larger. In order to prevent a problem that an embedded domain name is overlong, heyoka uses binary encoding to improve a transmission efficiency but result in that a proportion of a figure in the domain name is too large. As a consequence, the data stream in which the length of the Query.Name field is greater than a specified threshold α, and the Query.Name field is out of a white list of a normal domain name is filtered; and a Time to Live (TTL) value is greater than a specified thresholdγ

Step 2: with the utilization of a total length of a data packet, the number of Query.Name sub-domain names, a length of a character string of the Query.Name sub-domain name, a percentage of binary data of a Query.Name domain name, a character entropy of the Query.Name domain name, Sum(Answer.DataLength) answer record length, the number of all Answer RRs+Authority RRs+Additional RRs resource records, the number of resources in each segment (Answer RRs, Authority RRs, Additional RRs, Additional RRS), maximum response time TTI and Query.Type, a machine learning classifier is constructed.

4. According to the traffic log, abnormal login information of the account is identified from five dimensions including an Internet Protocol (IP), time, a place, a device and whether a brute force is provided, thus providing a basis for a loss of the account.

\textcircled{1} Login IP

Step 1: a statistic is made on a login IP of the account in history, and the number of login times corresponding to the IP.

Step 2: when the account is logged in on an IP where the account is never logged in, an alarm is abnormal login of the account.

\textcircled{2} Login time

Step 1: a statistic is made on the number of historical login times of the account within a specified time period, and a historical login time baseline of the account is constructed.

Step 2: when the number of historical login times exceeds the historical login time baseline, the alarm is the abnormal login of the account.

\textcircled{3} Login place

Step 1: a statistic is made on a historical login city of the account and the number of login times.

Step 2: when the account is logged in a city where the account is never logged in, the alarm is the abnormal login of the account.

\textcircled{4} Login device

Step 1: a statistic is made on a Mac address of a device in which the account is logged in history.

Step 2: when the account is logged in on a device where the account is never logged in, the alarm is the Abnormal login of the account.

\textcircled{5} Brute force

Step 1: a content of an HTTPS message is analyzed, and keywords such as “Login”, “Account”, “uid” and “password” are matched from a query parameter, form data or url information by using a partial matching method, thus finding a login action.

Step 2: if a same account is logged in for multiple times on a specified time window and has a login failure, an alarm of the brute force in the abnormal login of the account is given.

5. Data leakage information of the account is identified according to the traffic log to provide the basis for the loss of the account.

A condition in which the lawbreaker uses the data with the account indirectly reflects an extent of authority of the user or a content involved with work. With the data as a center, an authority and a baseline of the user to operate the data are analyzed.

Step 1: identification of sensitive data

\textcircled{1} Detection of User Accessing Sensitive File Frequently

By matching content information of all files of the user, a statistic is made on the number of times that the user accesses the sensitive file and a sensitive type.

\textcircled{2} Detection of User Leaking the Sensitive File

By analyzing a protocol related to file transmission such as EMAIL/HTTP/FTP, whether the user has a behavior of transmitting the sensitive file is detected; and if yes, an alarm is given. (Then, by refining, a baseline that each user transmits the sensitive file frequently may be provided; and when a non-baseline sensitive file is transmitted, the alarm is given)

\textcircled{3} Reversal for Detection of the Sensitive File

By analyzing the protocol related to the file transmission such as the EMAIL/HTTP/FTP, a transmission process of each sensitive file is detected; and by means of a relationship network, the transmission process of the sensitive file among a starter, a mediator and a terminator is displayed.

Step 2: construction of file access behavior baseline

With the user as an object, a data behavior baseline of each user for each type of application is calculated.

\textcircled{1} A file related to each type of application used by some user is collected respectively.

\textcircled{2} For a file related by a special user-special application, content information is extracted.

\textcircled{3} Word segmentation is performed on the content information.

4̅ A Logical Device Address (LDA) topic model with a built-in keyword library is used to perform content classification (topic) and sensitive word extraction. Herein, two results are obtained: “user-application-sensitive word (secondary authority)-label (primary authority)” and “label (primary authority)-sensitive word (secondary authority)”.

Step 3: detection of user access

\textcircled{1} A file operated by the user on the application line is obtained.

\textcircled{2} Content information is extracted.

\textcircled{3} Word segmentation is performed on the content information.

\textcircled{4} By matching a word segmentation result with the “label (primary authority)-sensitive word (secondary authority)” table, a probability that the file pertains to each type of label is found.

\textcircled{5} According to a type label list of the file, by matching with a label list of the user, the degree of overlapping with the label list of the user is determined. If the degree of overlapping is low, an alarm is given, that is, the user accesses an illegal file.

6. Functional use information of the account in a service system is obtained according to the traffic log.

The present invention evaluates an abnormal use condition of a function of the service system from parameter compliance and authority compliance of the function of the service system.

(1) Parameter Compliance

For each service function (uri) of the account in the service system, a behavior baseline for each IP is established.

Detection Steps:

Step 1: get/post is taken as a same processing manner, and a key&value pair of a query/form parameter is extracted. The get type is to take a query parameter behind a question mark of the url, and the post type is to take the query parameter and the form parameter.

Step 2: for each type of field name, a statistic is made on a length range of the value, and a type of the value (a letter, a FIGURE and a Chinese character), so as to detect whether a parameter transmitted by a special service function of each IP is compliant and legal.

(2) Authority Compliance

For each user, what function of the service is used by the user or what authority of the service is owned by the user is described, so as to construct a service functional baseline. For a single account, the authority has a certain error range. According to a used application function, a group division is performed on the account. A service function used by all accounts in a same group is viewed as a behavior baseline of each member in a group.

Detection Steps:

Step 1: an IP and an URL are split by using HTTP protocol data to find a user, an application and an action.

Step 2: a behavior UV matrix of the user is calculated (the behavior herein is the service function).

Step 3: a clustering method (Kmeans, GMM and DBSCAN) is used according to the UV matrix to find a user group having a similar behavior.

Step 4: a statistic is made on types of service functions and the number of occurrence times of all accounts in a same group.

Step 5: a statistic result of the above step is used as the behavior baseline of the accounts in the group.

7. Service process security information is obtained according to the traffic log.

For each service function of the service system, a service functional baseline is established, so as to detect whether a special request of the service function is compliant and legal, a parameter type and a Page View (PV) of a detected object, and whether the detected object has a condition of stealing data with multiple IPs.

\textcircled{1} get/post is taken as a same processing manner; by taking a query parameter behind a question mark of an url for the get type, and taking the query parameter and form data for the post type, a key&value baseline for extracting the query/form parameter is constructed. When a historical key&value pair baseline is violated, an alarm is given.

\textcircled{2}: for each type of field name, a statistic is made on a length range of the value, and a type of the value (a letter, a FIGURE and a Chinese character) to serve as the baseline, thus detecting whether a parameter transmitted by the service function is compliant and legal; and when the parameter transmitted by the service function is violated from the constructed baseline, an alarm is given.

\textcircled{3} A statistic is made on the number of IPs accessed by each service function on a specified time window (such as one hour) and a PV of each IP. A threshold α is set. When the number of IPs accessed to a service is greater than the α, an alarm is given. A threshold β is set. When the PV of each IP is greater than the β, an alarm is given.

8. A risk score and a loss probability of the account are determined.

For abnormal conditions of the above seven behaviors, the present invention evaluates a total risk score of the account via a manner of overlapping a risk score.

In combination with a loss result reported by a loss model of the account and a loss result confirmed manually by a client, the sample data having the feature and the label are used to train, via a machine learning manner, a score weight of each loss model of the account in a feedback way.

From each sample result of the loss of the account, the following seven features may be obtained:

\textcircled{1} Whether a security event occurs

\textcircled{2} Whether abnormal uplink and downlink traffic occurs

\textcircled{3} Whether a covert channel occurs

\textcircled{4} Whether abnormal login occurs

\textcircled{5} Whether a data leakage event occurs

\textcircled{6} Whether an abnormal service function occurs

\textcircled{7} Whether an abnormal service process parameter request occurs

When some feature occurs, 1 is provided; or otherwise, 0 is provide. When a result of the loss of the account is modified by a client manually (a result value is modified), a confirmation result of the client is used. Each behavior may have a risk score. By means of a manner of overlapping the risk score, the total risk score of the account is evaluated.

The above gives a detailed introduction to a method for detecting a lost account based on multiple dimensions provided by the embodiments of the present invention. In the specification, a specific example is used to describe a principle and an implementation manner of the present invention. The description on the above embodiments is merely helpful to understand a method and a core concept of the present invention. Meanwhile, those of ordinary skill in the art may make a change within a scope of the specific implementation manners and applications according to a concept of the present invention. To sum up, the content in the specification should not be understood as a limit to the present invention.

What is claimed is:

1. A method for detecting a lost account based on multiple dimensions, wherein the method uses a solution of detecting the lost account based on the multiple dimensions, thus implementing a purpose of effectively detecting a loss of the account on the basis of the multiple dimensions of a state and a behavior of the account.

2. The method for detecting the lost account based on the multiple dimensions as claimed in claim 1, wherein the loss of the account is detected with the multiple dimensions, including a security event, abnormal uplink and downlink traffic, a covert communication signal, abnormal login, data leakage, abnormal service functional use, service process security and other dimensions.

3. The method for detecting the lost account based on the multiple dimensions as claimed in claim 1, wherein a risk score and a loss probability of the account are determined via the multiple dimensions.
